(19) United States
(12) Patent Application Publication
(10) Pub. No.: US 2014/0278030 A1
(43) Pub. Date: Sep. 18, 2014

(54) AUTOMOBILE TRAFFIC DETECTION SYSTEM

(71) Applicant: Harman International Industries, Incorporated, Stamford, CT (US)

(72) Inventors: Omprakash Meena, Bangalore (IN); Manu Malhotra, Bangalore (IN)

(73) Assignee: HARMAN INTERNATIONAL INDUSTRIES, INCORPORTED, Stamford, CT (US)

(21) Appl. No.: 13/828,538

(22) Filed: Mar. 14, 2013

(51) Int. Cl. G08G 1/00

(52) U.S. Cl. CPC G08G 1/00
USPC 701/118; 701/117

(57) ABSTRACT

An traffic detection system (TDS) can receive an information signal associated with a sensed vehicle. The vehicle may be sensed on a roadway by one or more sensors. The system can identify data within the received signal indicative of characteristics of the vehicle, and determine a classification of the vehicle based on at least the characteristics of the vehicle. Additionally or alternatively, the system may determine a traffic pattern associated with the roadway based on at least the determination of the classification of the vehicle.

### BACKGROUND OF THE INVENTION

1. Technical Field

The present disclosure relates to automobile traffic detection using sensors embedded in, placed on, or proximate to a roadway.

2. Related Art

Traffic detection systems can use sensors, such as piezoelectric sensors, to track traffic patterns. Such sensors may include or be mounted on a strip or cable for example, and can provide information pertaining to vehicles driving over the sensors to a traffic detection system data repository. Known systems are capable of approximating the amount of vehicles passing through a roadway for a given period.

### SUMMARY

Described herein is a system for not only determining an amount of vehicles passing through a roadway, but also the type of vehicles passing through the roadway in real time, or for a given period. In other words, the system may not only provide quantitative traffic information, but also qualitative traffic information.

An example system, such as an traffic detection system (TDS), may include one or more processors or modules operable to receive a signal including information associated with a sensed vehicle on a roadway. The one or more processors or modules may also be operable to: identify data within the received signal indicative of one or more characteristics of the vehicle, and determine a classification of the vehicle, such as the vehicle's type, based on at least one of the one or more characteristics of the vehicle. In addition, the one or more processors or modules may be operable to determine a traffic pattern associated with the roadway based on at least the determination of the classification of the vehicle.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system, such as an traffic detection system (TDS), may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a block diagram of an example TDS.

FIG. 2 illustrates a block diagram of an example electronic device and an example sensing device that may include one or more aspects of an example TDS.

FIG. 3 illustrates an operational flowchart that can be performed by one or more aspects of an example electronic device and/or an example sensing device of an example TDS, such as the one or more aspects of the electronic device and/or the sensing device of FIG. 2.

FIG. 4 illustrates multiple perspectives of an example vehicle.

FIG. 5 illustrates a top view of an example intersection of roadways.

FIG. 6 illustrates another operational flowchart that can be performed by one or more aspects of an example electronic device and/or an example sensing device of an example TDS, such as the one or more aspects of the electronic device and/or the sensing device of FIG. 2.

### DETAILED DESCRIPTION

It is to be understood that the following description of examples of implementations are given only for the purpose of illustration and are not to be taken in a limiting sense. The partitioning of examples in function blocks, modules or units illustrated in the drawings is not to be construed as indicating that these function blocks, modules or units are necessarily implemented as physically separate units. Functional blocks, modules or units illustrated or described may be implemented as separate units, circuits, chips, functions, modules, or circuit elements. One or more functional blocks or units may also be implemented in a common circuit, chip, circuit element or unit.

Described herein is a system, such as an traffic detection system (TDS). The system may include one or more interfaces operable to receive one or more signals including information associated with one or more sensed vehicles on one or more roadways or sections of roadways. The one or more vehicles may be sensed by one or more sensors embedded in, laid on, or proximate to one or more entrances and/or exits of the one or more roadways or sections of roadways. The one or more sensors may span the width of a section of a roadway, for example.

The system may also include one or more processors or processing modules operable to identify data within the received one or more signals, the data being indicative of one or more characteristics of the one or more vehicles. The one or more processors or modules may also be operable to determine one or more classifications (such as vehicle types) of the one or more vehicles based on at least the one or more characteristics of the one or more vehicles. In addition, the one or more processors or modules may be operable to determine speed of the one or more vehicles based at least on the one or more characteristics, and/or based on at least the determination of the one or more classifications of the one or more vehicles. The one or more processors or modules may also be operable to determine one or more traffic patterns of the one or more roadways or sections of roadways.

In one example, based on at least the determination of the one or more classifications of the one or more vehicles, the one or more processors or modules may also be operable determine an amount of vehicles with a classification passing through the one or more roadways or sections of roadways in real time or for a given time period. Additionally, the one or more processors or modules may be operable determine a route between at least two different locations based on at least the determination of the amount of vehicles with the classification passing through the one or more roadways or sections of roadways in real time or for a given time period.

In one example, the one or more processors or modules may be operable to store the classification information of the one or more vehicles in a database along with timing information including one or more of: a duration of time a vehicle was on the one or more roadways or sections of roadways, and a date and/or time the vehicle entered and/or exited the one or more roadways or sections of roadways. The one or more processors or modules may also be operable to determine from querying the database, the amount of vehicles passing through the one or more roadways or sections of roadways in real time or for a given time period. And based on at least the query, the one or more processors or modules may also be operable to determine one or more traffic ratings, and transmit from the processor, the one or more ratings to one or more electronic devices, such as navigation devices, smartphones, or personal computers.

The traffic ratings may include alpha-numeric ratings or color-coded ratings, such as green for free flowing traffic and red for significant congestion. The traffic ratings may also include or be based on information pertaining to traffic, such as weather-related driving conditions, traffic congestion, detours, and traffic accidents. The traffic ratings may also include or be based on measurements, such as average speed of vehicles for a roadway or number of vehicles flowing in and/or out of a roadway. The traffic ratings may also include or be based on traffic status information, such as traffic being free-flowing, mild, bumper-to-bumper, or at a standstill. Also, traffic ratings may include or be based on delay statuses, such as major traffic delays, minor traffic delays, and no traffic delays.

In one example, the one or more processors or modules may be operable to determine traffic ratings based on an amount of vehicles traveling through a road segment per a time period. In other words, traffic ratings may be based on a traffic flow rate. Additionally or alternatively, traffic ratings may be based on road conditions of a road segment and the types of vehicles that are traveling on a road segment. For example, in an a case of two different routes that have similar parameters, but the first route has ten compact cars driving on it per minute and the second route has ten semi-trailer trucks driving on it per minute, the first route may have a higher rating than the second route. Also, for example, the two routes may have similar parameters, but the first route has road construction and the second route does not. In this scenario, the first route may have a lower rating than the second route.

The processor may also transmit a signal including instructions for operation of an electrical and/or mechanical device based on at least the one or more traffic ratings, for example. The electrical and/or mechanical device may be a traffic control device, such as a traffic signal or road barrier gate.

In addition, the one or more processors or modules may be operable to determine one or more alerts for law enforcement based on at least on one or more of the traffic ratings and the amount of vehicles with a classification passing through the one or more roadways or sections of roadways in real time or for a given time period. In such an example, the processor may transmit the one or more alerts to one or more law enforcement devices or systems.

Regarding the one or more characteristics of the one or more vehicles, such characteristics may include: a weight of a vehicle, one or more respective widths of one or more wheels of a vehicle, an amount of wheels driven by a vehicle powertrain, a distance between a front and a rear tire of a vehicle, an inner distance between an inner point of contact of a left tire and an inner point of contact of a right tire, and/or an outer distance between an outer point of contact of a left tire and an outer point of contact of a right tire, for example. In such examples, a point of contact may be a point of contact with a sensed area, such as a roadway or air above a roadway sensed by one or more sensors.

In one example, the one or more processors or modules may be operable to determine a tire width based on at least the inner distance and the outer distance between front or rear tires. For example, the one or more processors or modules may be operable to determine a tire width by subtracting the inner distance from the outer distance and dividing the difference by two.

FIG. 1 illustrates a block diagram of an example TDS. The example TDS may include one or more electronic devices, such as client device 102 and application server 104, communicatively coupled to a sensing device 106, via at least a wide area network and/or local area, such as network 108. The sensing device 106 is embedded in and/or attached above, below, to a side, or anywhere proximate to an example roadway 110, and may include and/or communicate with one or more sensors, such as one or more vibration, acoustic, chemical, electric current, magnetic, radio, light, pressure, force, thermal, or proximity sensors.

FIG. 2 illustrates a block diagram of an example electronic device 200 and an example sensing device 230 of an example TDS. The electronic device 200 may be, include, or communicate with the client device 102 and/or the application server 104, for example. The example sensing device 230 may be, include, or communicate with the sensing device 106, for example. A network 226 that communicatively couples the electronic device 200 and the sensing device 230 may be, include, or communicate with the network 108, for example.

The electronic device 200 and/or the sensing device 230 may include a set of instructions that can be executed to cause the electronic device 200 and/or the sensing device 230 to perform any of the methods and/or computer based functions disclosed herein, such as functions including: receiving an information signal associated with a sensed vehicle, sensed on a roadway by one or more sensors; identifying data within the received signal indicative of characteristics of the vehicle; determining a classification of the vehicle or an identification of the vehicle based on at least the characteristics of the vehicle; and determining a traffic pattern associated with the roadway based on at least the determination of the classification of the vehicle.

With respect to identification of the vehicle, such a determination may include identifying unique aspects of the vehicle, such as rust holes or areas, dents, a clothes hangar on the tail pipe, a custom muffler system, a bald tire, a nail in a tire, a tire different from the others, ground effects lights, pinstripes, or bumper stickers, for example.

The electronic device 200 and/or the sensing device 230 may also include one or more processors or modules operable to perform any other of the methods and/or computer based functions disclosed herein. The electronic device 200 and/or the sensing device 230 may operate as a standalone device, may be included as functionality within a device also performing other functionality, or may be connected, such as using a network, to other computer systems, devices, or peripheral devices.

With respect to the electronic device 200, in the example of a networked deployment, the electronic device may operate in the capacity of a server or a client user computer in a server-client user network environment, as a peer computer system in a peer-to-peer (or distributed) network environment, or in various other ways. The electronic device 200 can also be implemented as, or incorporated into, various electronic devices, such as hand-held devices such as smartphones and tablet computers, portable media devices such as recording, playing, and gaming devices, automotive electronics such as head units and navigation systems, or any machine capable of executing a set of instructions (sequential or otherwise) that result in actions to be taken by that machine. The electronic device 200 may be implemented using electronic devices that provide voice, audio, video and/or data communication. While a single device 200, such as an electronic device, is illustrated, the term “device” may include any collection of devices or sub-devices that individually or jointly execute a set, or multiple sets, of hardware and/or software instructions to perform one or more functions. The one or more functions may include: receiving an information signal associated with a sensed vehicle, sensed on a roadway by one or more sensors; identifying data within the received signal indicative of characteristics of the vehicle; determining a classification of the vehicle based on at least the characteristics of the vehicle; and determining a traffic pattern associated with the roadway based on at least the determination of the classification of the vehicle.

The electronic device 200 may include a processor 202, such as a central processing unit (CPU), a graphics processing unit (GPU), or both. The processor 202 may be a component in a variety of systems. For example, the processor 202 may be part of a head unit in a vehicle. Also, the processor 202 may include one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually or programmed.

The electronic device 200 may include memory, such as a memory 204 that can communicate via a bus 210. The memory 204 may be or include a main memory, a static memory, or a dynamic memory. The memory 204 may include any non-transitory memory device. The memory 204 may also include computer readable storage media such as various types of volatile and non-volatile storage media including random access memory, read-only memory, programmable read-only memory, electrically programmable read-only memory, electrically erasable read-only memory, flash memory, a magnetic tape or disk, optical media and the like. In addition, the memory may include a non-transitory tangible medium upon which software may be stored. The software may be electronically stored as an image or in another format (such as through an optical scan), then compiled, or interpreted or otherwise processed.

In one example, the memory 204 may include a cache or random access memory for the processor 202. In alternative examples, the memory 204 may be separate from the processor 202, such as a cache memory of a processor, the system memory, or other memory. The memory 104 may be or include an external storage device or database for storing data. Examples include a hard drive, compact disc (CD), digital video disc (DVD), memory card, memory stick, floppy disc, universal serial bus (USB) memory device, or any other device operative to store data. For example, the electronic device 200 may also include a disk or optical drive unit 108. The drive unit 208 may include a computer-readable medium 222 in which one or more sets of software or instructions, such as the instructions 224, can be embedded. The processor 202 and the memory 204 may also include a computer-readable storage medium with instructions or software.

The memory 204 may be operable to store instructions executable by the processor 202. The functions, acts or tasks illustrated in the figures or described may be performed by the programmed processor 202 executing the instructions stored in the memory 204. The functions, acts or tasks may be independent of the particular type of instructions set, storage media, processor or processing strategy and may be performed by software, hardware, integrated circuits, firmware, microcode and the like, operating alone or in combination. Likewise, processing strategies may include multiprocessing, multitasking, parallel processing and the like.

The instructions 224 may include the methods and/or logic described herein, including aspects or modules of the electronic device 200 and/or an example traffic detection system (such as TDS module 225). The instructions 224 may reside completely, or partially, in the memory 204 or in the processor 202 during execution by the electronic device 200. For example, software aspects or modules of the TDS (such as the TDS module 225) may include examples of various signal processors that may reside completely, or partially, in the memory 204 or in the processor 202 during execution by the electronic device 200.

With respect to various signal processors that may be used by the TDS, hardware or software implementations of such processors may include analog and/or digital signal processing modules (and analog-to-digital and/or digital-to-analog converters). The analog signal processing modules may include linear electronic circuits such as passive filters, active filters, additive mixers, integrators and delay lines. Analog processing modules may also include non-linear circuits such as compandors, multiplicators (frequency mixers and voltage-controlled amplifiers), voltage-controlled filters, voltage-controlled oscillators and phase-locked loops. The digital or discrete signal processing modules may include sample and hold circuits, analog time-division multiplexers, analog delay lines and analog feedback shift registers, for example. In other implementations, the digital signal processing modules may include ASICs, field-programmable gate arrays or specialized digital signal processors (DSP chips). Either way, such digital signal processing modules may enhance an image signal via arithmetical operations that include fixed-point and floating-point, real-valued and complex-valued, multiplication, and/or addition. Other operations may be supported by circular buffers and/or look-up tables. Such operations may include Fast Fourier transform (FFT), finite impulse response (FIR) filter, Infinite impulse response (IIR) filter, and/or adaptive filters.

The modules described herein may include software, hardware, firmware, or some combination thereof executable by a processor, such as processor 202. Software modules may include instructions stored in memory, such as memory 204, or another memory device, that may be executable by the processor 202 or other processor. Hardware modules may include various devices, components, circuits, gates, circuit boards, and the like that are executable, directed, or controlled for performance by the processor 202. The term “module” may include a plurality of executable modules.

Further, the electronic device 200 may include a computer-readable medium that may include the instructions 224 or receives and executes the instructions 224 responsive to a propagated signal so that a device connected to the network 226, such as the sensing device 230, can communicate voice, video, audio, images or any other data over the network 226 to the electronic device. The instructions 224 may be transmitted or received over the network 226 via a communication port or interface 220, or using a bus 210. The communication port or interface 220 may be a part of the processor 202 or may be a separate component. The communication port or interface 220 may be created in software or may be a physical connection in hardware. The communication port or interface 220 may be configured to connect with the network 226, external media, one or more input/output devices 214, or any other components in the electronic device 200, or combinations thereof. The connection with the network 226 may be a physical connection, such as a wired Ethernet connection or may be established wirelessly. The additional connections with other components of the electronic device 200 may be physical connections or may be established wirelessly. The network 226 may alternatively be directly connected to the bus 210.

The network 226 may include wired networks, wireless networks, Ethernet AVB networks, a CAN bus, a MOST bus, or combinations thereof. The wireless network may be or include a cellular telephone network, an 802.11, 802.16, 802.20, 802.1Q or WiMax network. The wireless network may also include a wireless LAN, implemented via WI-FI or BLUETOOTH technologies. Further, the network 226 may be or include a public network, such as the Internet, a private network, such as an intranet, or combinations thereof, and may utilize a variety of networking protocols now available or later developed including TCP/IP based networking protocols. One or more components of the electronic device 200 may communicate with each other by or through the network 226.

The one or more input/output devices 214 may be configured to allow a user to interact with any of the components of the electronic device. The one or more input/out devices 214 may include a keypad, a keyboard, a cursor control device, such as a mouse, or a joystick. Also, the one or more input/out devices 214 may include a microphone, one or more visual displays, speakers, remote controls, touchscreen displays or any other devices operative to interact with the electronic device 200, such as any device operative to act as an interface between the electronic device and one or more users and/or other electronic devices.

With respect to the sensing device 230, this device may include and/or communicate with one or more elements included in and/or coupled with the electronic device 200. Additionally, the sensing device 230 may also include one or more sensors 232. The one or more sensors 232 may include one or more vibration, acoustic, chemical, electric current, magnetic, radio, light, pressure, and force, thermal, or proximity sensors. Functionally, the one or more sensors 232 may include one or more sensors that detect or measure, motion, temperature, magnetic fields, gravity, humidity, moisture, vibration, pressure, electrical fields, sound, or other physical aspects associated with a potential user or an environment proximate to the user. In addition, the sensing device may include a communication port or interface 234 and a bus 236, such as a port or interface and a bus similar to the port or interface 220 and the bus 210. As depicted, the sensing device 230 and the electronic device 200 may communicate with each other over the network 226 via their respective communication ports or interfaces. Additionally or alternatively, the sensing device 230 may include any or all of the aspects and components of the electronic device 200, such as a processor and memory.

FIG. 3 illustrates an operational flowchart that can be performed by one or more aspects of an example electronic device and/or an example sensing device of an example TDS. The flowchart 300 represents several sub-processes for determining speed and/or a type of a vehicle passing above, below, beside, or proximate to a sensing device, such as the sensing device 230 or 106. Further, via the sub-processes of the flow chart 300, an amount of vehicles passing above, below, beside, or proximate to the sensing device per a period of time may be determine. In short, traffic patterns may be determined. These patterns may include general traffic patterns, such as vehicles per time period, or more specific traffic patterns, such as one or more vehicle types per time period.

With respect to vehicle types, vehicles may be categorized in various ways. For example, vehicle types may be categorized by a number of wheels on a vehicle, such as 2-, 3-, 4-, 6-, or 8-wheelers. Vehicle types may also be categorized by manufacturer, model, or year of manufacture of the vehicle. Another categorization may include categories of n-wheelers. For example, categories of 4-wheelers may include, cars, vans, minivans, 4-wheeled trucks, and sport utility vehicles. Vehicles may also be categorized by their size, such as economy, compact, mid-size, or full-size, for example.

The determination of vehicle types may be based on or more sensed physical features of a vehicle, such as structural features, acoustic features, and weight. Structural features may include measurements such as tire widths and separation between tires, or lengths, widths, and heights of different areas of a vehicle. Acoustic features may include sound of the vehicle's engine at various speeds, for example.

In one example of the TDS, a processor (e.g., the processor 202) can execute processing device readable instructions encoded in memory (e.g., the memory 204). In such an example, the instructions encoded in memory may include a software aspect of the TDS, such as the TDS module 125. The example operation of the TDS may begin with a starting event, such as a vehicle passing, accelerating, decelerating, or idling above, below, beside, or proximate to a sensing device (e.g., the sensing device 230 or 106). The sensing device may include one or more sensors, such as one or more vibration, acoustic, chemical, electric current, magnetic, radio, light, pressure, force, thermal, or proximity sensors. The sensing device may also include an array of sensors, and an array of sensors may include a single- or multi-dimensional array of sensors.

At 310, the example operation may continue with an electronic device such as the electronic device 200 receiving traffic information from a sensing device such as the sensing device 230 or 106. The traffic information may include information associated with the starting event, such as information pertaining to one or more vehicles passing, accelerating, decelerating, or idling above, below, beside, or proximate to a sensing device.

At 320, the example operation may continue with determining based on the traffic information via the electronic device, various measurements including widths of the one or more vehicle's tires and separation between various tires of the one or more vehicles. This may include determining separation between rear tires of a vehicle (at 322), determining separation between front tires of a vehicle (at 324), and/or determining separation between a front and rear tire of a vehicle (at 326). This may also include determining widths of front and rear tires of a vehicle (at 328). In addition, an amount of tires per vehicle may be determined by the electronic device. Also, acoustic features per vehicle may be determined. For example, where dimensions of more than one vehicle type are similar, one or more acoustic features of a vehicle type may be a unique identifier of that type.

At 330, the example operation may continue with determining, based on the various measurements at 320, for example, a type and/or speed of the vehicle. This determination can be repeated for any or all vehicles that pass above, below, beside, or proximate the sensing device. Speed determinations may be precise or within ranges of speeds, such as under one mile-per-hour, between one and ten miles-per-hour, between ten and twenty-five miles-per-hour, and the like. With respect to vehicle-type determinations described herein, vehicle types may be determined by comparing sensed vehicle characteristics against a database including vehicle characteristics for vehicle types. As mentioned, vehicle-type determinations may include determining vehicle type by make, model, year of manufacture, number of wheels, size of the vehicle, and market category of the vehicle (such as sports car, sport utility vehicle, luxury sedans, etc. . . . ), for example. Where a vehicle's dimensions match multiple types, the type of the vehicle may be determined from acoustic features of the vehicle, such as engine noise at one or more speeds.

FIG. 4 illustrates multiple perspectives of an example vehicle and assists in illustrating separation measurements between tires. For example, distance A illustrates a distance between a front and a rear tire of an example vehicle. Distance A is measured from a middle point of contact of the front tire to a middle point of contact of the rear tire in a same vertical plane of the vehicle, distances B and B′ illustrate different distance measurements between front tires of the vehicle, and distances C and C′ illustrate different distance measurements between rear tires of the vehicle. Distances B and C are measured from respective inner points of contact of respective left tires to respective inner points of contact of respective right tires in respective vertical planes, distances B′ and C′ are measured from respective outer points of contact of respective left tires to respective outer points of contact of respective right tires in respective vertical planes. In this figure and in the system, distances are determined by points of contact with a sensed area, such as an area of a road with embedded sensors or sensed locations in the air.

FIG. 4 also illustrates how widths of tires may be determined. For example, widths may be determined from distances between similar points of contact of different tires. In this figure, distance C′ minus distance C equals approximately two times the distance C″. And distance C″, the width of a back tire, can then be determined by simple division. Also, distance B′ minus distance B equals approximately two times the distance B″. And distance B″, the width of a front tire, can then be determined by division. Additionally or alternatively, the widths of the tires can be determined directly from a sensed signal, without subtracting and/or dividing tire separation distances. In one example, the first way of determining tire widths may be used to validate the latter way of determining tire widths, or vice versa. This type of redundancy can lead to more accurate determinations of a vehicle type driving or idling above, below, beside, proximate, and/or through a sensed area.

Also by having accurate tire measurements, not only can a type of a vehicle be determined, buts speeds of a vehicle may be determined as well. For example, if the type of vehicle is determined, the distance between front and rear tires is known, and speed of the vehicle can then be determined by the time it takes for the rear set of tires to follow the front set of tires into a sensed area.

FIG. 5 illustrates an example round-about intersection of roadways. Included in this figure are sensing device sensed areas 1-4 proximate to four respect exits and entries into the intersection. Arrows Y1-Y4 represent possible amounts of traffic moving out of the intersection through the sensed areas 1-4, and arrows X1-X4, show possible amounts of traffic moving into the intersection through sensed areas 1-4. An amount of congestion in the intersection can be determine by taking the amount of vehicles sensed passing into the intersection minus the amount of vehicles sensed passing out of the intersection via the sensed areas 1-4 (Y1+Y2+Y3+Y4-X1+X2+X3+X4). A similar model could be applied to one or more entrance and exits of any roadway or intersection (ΣYi-ΣXi). In general, traffic amounts may be determined using the model ΣYi-ΣXi, number of vehicles flowing in minus number of vehicles flowing out of a roadway, for an i amount of entrances and exits. Additionally or alternatively, ΣYi-ΣXj may be used as a model, where j and I may be different values. Additionally, the information about traffic, for example including ΣYi-ΣXi, may be determined with respect to time or periods of time, for example ΣYi-ΣXi per second, minute, hour, day, week, month, or year. For example, entrances and exits onto a highway may be used as locations for positioning the sensing devices. By having the sensing devices at these positions, traffic amounts on a given highway may be determined.

Besides traffic amounts, an occurrence in real time of one or more specific vehicles or types of vehicles could be tracked for a roadway. In addition, besides numbers of vehicles on a roadway, accurate determinations of average speeds could be determined for a roadway.

By determining traffic information using the above-described methods and models, for example, such information can be retrieved by a mobile device, such as a navigation device in determining a route with a least amount of traffic. In addition, such information can trigger actions, such as actions used by law enforcement.

FIG. 6 illustrates another operational flowchart that can be performed by one or more aspects of an example electronic device and/or an example sensing device of an example TDS. At 610, one of the aspects of the example electronic device and/or sensing device receives traffic information from one or more sensors positioned at one or more exits and entrances of a roadway, such as sensors of sensing devices at the sensing areas of FIG. 5. At 620, from the traffic information, the one aspect or another aspect of the TDS may determine various measurements including tire widths, vehicle weight, separation between tires per vehicle, and/or an amount of vehicles traveling or idle on the roadway at a given time.

At 630, from aspects of the various measurements, the one aspect or another aspect of the TDS may determine amounts of types of vehicles traveling or idle on the roadway at a given time. At 632, using the determination at 630 for various roadway alternatives for a route, the one aspect or another aspect of the TDS may determine routes with least delays using traffic amounts, types of vehicles that make up the traffic, and average speeds of the different types of vehicles traveling in the roadway. At 634, a relational database of or associated with the TDS may archive routes and route information from the determination at 632 and determinations at preceding sub-processes. Additionally or alternatively, the database may archive information from 640 determinations described below. At 636, a device of or connected with the TDS, such as a navigation client device, may access routes from the route archive with respect to time of day and/or day of week, for example. Alternatively or additionally, at 638, a device of or connected with the TDS, such as a navigation client device, may access routes from determinations at 632, when, for example, the archive lacks enough data to support a route.

Furthermore, additionally or alternatively, at 640, from aspects of the various measurements determined at 620, the one aspect or another aspect of the TDS can determine a time when a vehicle type or a specific vehicle has entered and/or exited a roadway. At 642, the one aspect or another aspect of the TDS can trigger an action based on the determination at 630 and/or 640. The action may include transmitting an alert to law enforcement for various roadway statuses. For example, transmitting an alert to law enforcement when a vehicle over a weight limit enters the roadway, a prohibited vehicle type enters the roadway, or a suspect's or criminal's vehicle enters the roadway. At 644, the one aspect or another aspect of the TDS may optimize the triggered action at 642 based on routes determined at 632 and/or archived information of the relational database at 634.

In addition, with respect to the determinations at 632 and 640, routing information derived from operations of the operational flow chart 600 may be validated based on comparisons with routing information from GPS and/or TMC technologies at 650.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method, comprising:
receiving at a processor, a signal including information associated with a sensed vehicle on a roadway;
identifying via the processor, data within the received signal indicative of one or more characteristics of the sensed vehicle; and
determining via the processor, a type of the sensed vehicle based on at least the one or more characteristics of the sensed vehicle.

2. The method of claim 1, further comprising determining via the processor, a unique characteristic of the vehicle based on at least the one or more characteristics of the sensed vehicle.

3. The method of claim 2, where the unique characteristic of the vehicle may include one or more of rust areas or dents on the vehicle.

4. The method of claim 1, further comprising storing via the processor, the type of the sensed vehicle in database along with timing information including one or more of:
a duration of time the sensed vehicle was on the roadway or a section of the roadway; and
a date and time the sensed vehicle entered or exited the roadway or the section of the roadway.

5. The method of claim 1, further comprising determining from querying a database, an amount of vehicles of a type passing through the roadway in real time or for a given time period.

6. The method of claim 1, further comprising:
querying via the processor, a database for an amount of vehicles of a type passing through the roadway in real time or for a given time period;
determining via the processor, a traffic rating based on at least the query; and
transmitting from the processor, the traffic rating to an electronic device.

7. The method of claim 6, further comprising transmitting from the processor, a signal including instructions for operation of an electrical or mechanical device based on at least the traffic rating.

8. The method of claim 6, further comprising:
determining via the processor, an alert for law enforcement based on at least one of the traffic rating or the amount of vehicles of a type passing through the roadway in real time or for a given time period; and
transmitting the alert to a law enforcement device or system.

9. The method of claim 1, where the one or more characteristics of the sensed vehicle include a weight of the sensed vehicle.

10. The method of claim 1, where the one or more characteristics of the sensed vehicle include one or more respective widths of one or more wheels of the sensed vehicle.

11. The method of claim 1, where the one or more characteristics of the sensed vehicle include a distance between a front and a rear tire of the sensed vehicle.

12. The method of claim 1, where the one or more characteristics of the sensed vehicle include an inner distance between an inner point of contact of a left tire and an inner point of contact of a right tire, and where the one or more characteristics of the sensed vehicle include an outer distance between an outer point of contact of a left tire and an outer point of contact of a right tire.

13. The method of claim 12, further comprising determining via the processor, a tire width based on at least the inner distance and the outer distance.

14. The method of claim 12, further comprising determining via the processor, a tire width by subtracting the inner distance from the outer distance and dividing the difference by two.

15. The method of claim 1, where the one or more characteristics of the sensed vehicle include an amount of wheels the sensed vehicle includes.

16. The method of claim 1, where the one or more sensors span a width of a section of the roadway.

17. The method of claim 1, further comprising:
repeating for a plurality of roadways between at least two different locations, querying of a database for an amount of vehicles of a type passing through the roadway in real time or for a given time period;
determining via the processor, respective traffic ratings for the plurality of roadways based on the amount of vehicles of a type passing through the roadway in real time or for a given time period; and
determining via the processor, a route between the at least two different locations based on at least one or more of the respective traffic ratings.

18. A system, comprising:
a communications interface operable to receive one or more signals including information associated with one or more sensed vehicles on one or more roadways or sections of roadways; and
a processor operable to:
identify data within the one or more signals indicative of one or more characteristics of the one or more sensed vehicles;
determine one or more classifications of the one or more sensed vehicles based on at least the one or more characteristics of the one or more sensed vehicles;
determine based on at least the determination of the one or more classifications of the one or more sensed vehicles, an amount of vehicles with one or more classifications passing through the one or more roadways or sections of roadways in real time or for a given time period; and
determine a route between at least two different locations based on at least the determination of the amount of vehicles with the one or more classifications passing through the one or more roadways or sections of roadways in real time or for a given time period.

19. The system of claim 18, where the processor is operable to: validate the route against one or more of global positioning system (GPS) information and traffic message channel (TMC) information.

20. A non-transitory tangible storage medium, comprising:
instructions executable to: receive a signal including information associated with one or more sensed vehicles on a roadway;
instructions executable to: identify data within the received signal indicative of one or more characteristics of the one or more sensed vehicles;
instructions executable to: determine one or more classifications of the one or more sensed vehicles based on at least the one or more characteristics; and
instructions executable to: determine a traffic pattern of the roadway based on at least the determination of the one or more sensed vehicles.
